(19) United States
(12) Patent Application Publication
(10) Pub. No.: US 2025/0136003 A1
(43) Pub. Date: May 1, 2025

(54) ORGANIZER APPARATUS FOR A VEHICLE

(71) Applicant: Renee Joseph, Methuen, MA (US)

(72) Inventor: Renee Joseph, Methuen, MA (US)

(21) Appl. No.: 18/383,664

(22) Filed: Oct. 25, 2023

(51) Int. Cl. B60R 7/04

(52) U.S. Cl. CPC B60R 7/04

(57) ABSTRACT

A organizer apparatus for organizing items in a vehicle includes a support strap which has a length such that the support strap is configured to hang over a center console of a vehicle. Each one of a pair of compartment assemblies is positioned on an associated end of a pair of ends of the support strap. Each compartment assembly comprises a panel and a plurality of pockets. The panel has a top edge, a bottom edge, a front edge, and a rear edge. The panel also has an outer surface and an inner surface each extending between the top edge and the bottom edge and between the front edge and the rear edge. The panel is positionable such that inner surface abuts the center console when the support strap hangs over the center console. The plurality of pockets is mounted on the outer surface of the panel.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to organizer apparatuses and more particularly pertains to a new organizer apparatus for organizing items in a vehicle.

### (2) Description of Related Art Including Information Disclosed Under 37 CFR 1.97 and 1.98

The prior art relates to organizer apparatuses for vehicles, including at least one apparatus which provides multiple disposable bags which may be mounted inside a vehicle and at least one apparatus that fits between a center console and a chair of a vehicle and which provides a pouch for storing items. However, the prior art fails to describe such an apparatus which includes a pair of compartment assemblies which are connected by a support strap. Such an apparatus may be used by placing the support strap over the center console so that the compartment assemblies are spaced from each other across the center console. Each compartment assembly additionally may have a pouch which is removable to facilitate emptying and cleaning of the pouch. Such an apparatus is advantageous over the prior art by providing compartment assemblies on multiple sides of the center console and by having a structure which allows use of the apparatus in alternate vehicles.

### BRIEF SUMMARY OF THE INVENTION

An embodiment of the disclosure meets the needs presented above by generally comprising a support strap which has a length such that the support strap is configured to hang over a center console of a vehicle. Each one of a pair of compartment assemblies is positioned on an associated end of a pair of ends of the support strap. Each compartment assembly comprises a panel and a plurality of pockets. The panel has a top edge, a bottom edge, a front edge, and a rear edge. The panel also has an outer surface and an inner surface each extending between the top edge and the bottom edge and between the front edge and the rear edge. The panel is positionable such that inner surface abuts the center console when the support strap hangs over the center console. The plurality of pockets is mounted on the outer surface of the panel.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top rear side perspective view of an organizer apparatus according to an embodiment of the disclosure.

FIG. 2 is a side view of an embodiment of the disclosure.

FIG. 3 is another side view of an embodiment of the disclosure.

FIG. 4 is a rear view of an embodiment of the disclosure.

FIG. 5 is a top view of an embodiment of the disclosure.

FIG. 6 is an in-use view of an embodiment of the disclosure.

### DETAILED DESCRIPTION OF THE INVENTION

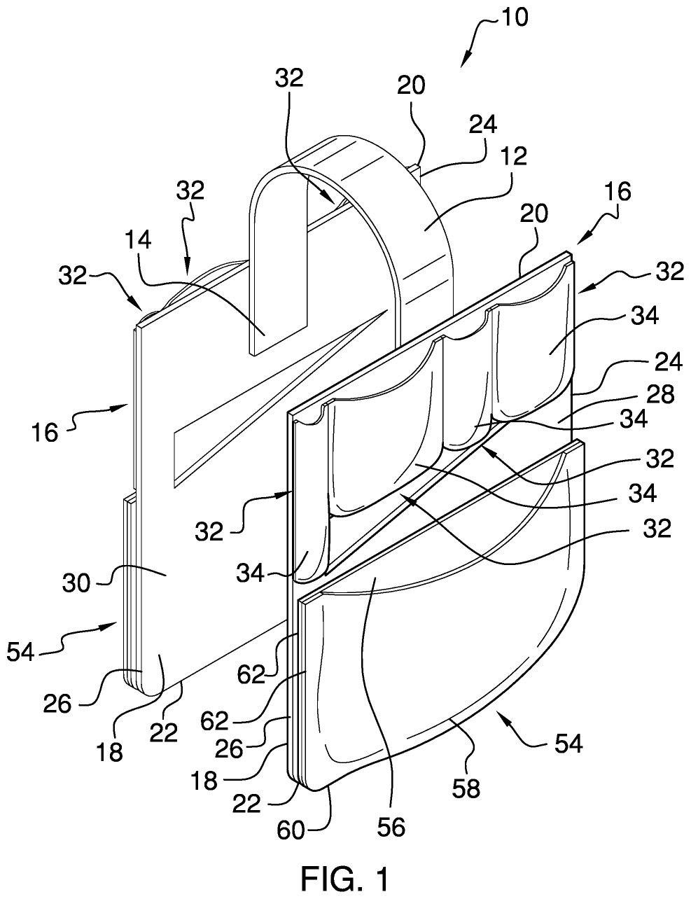

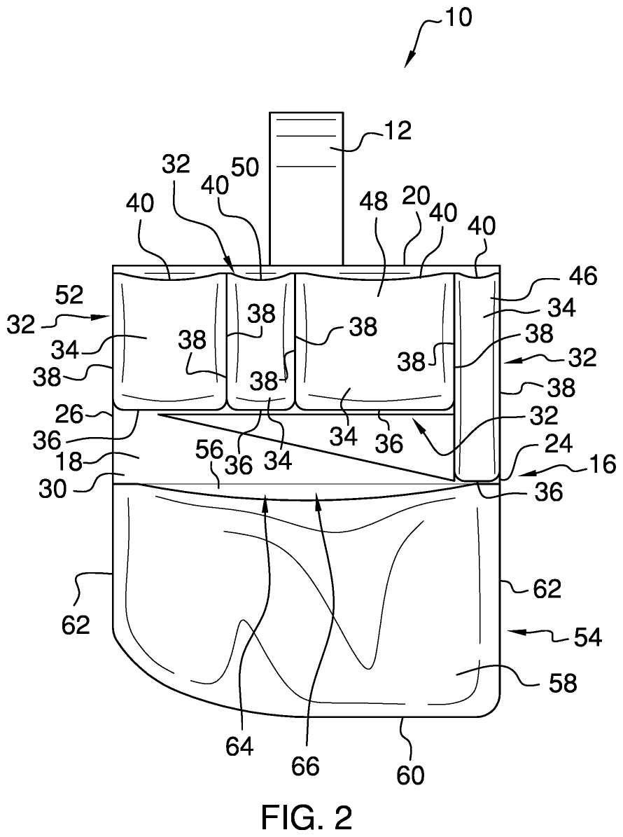

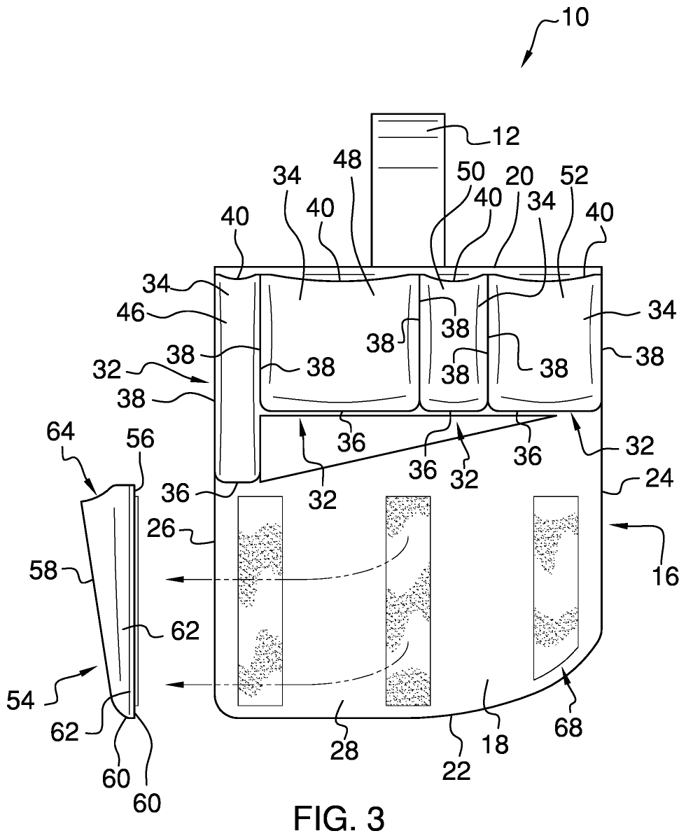

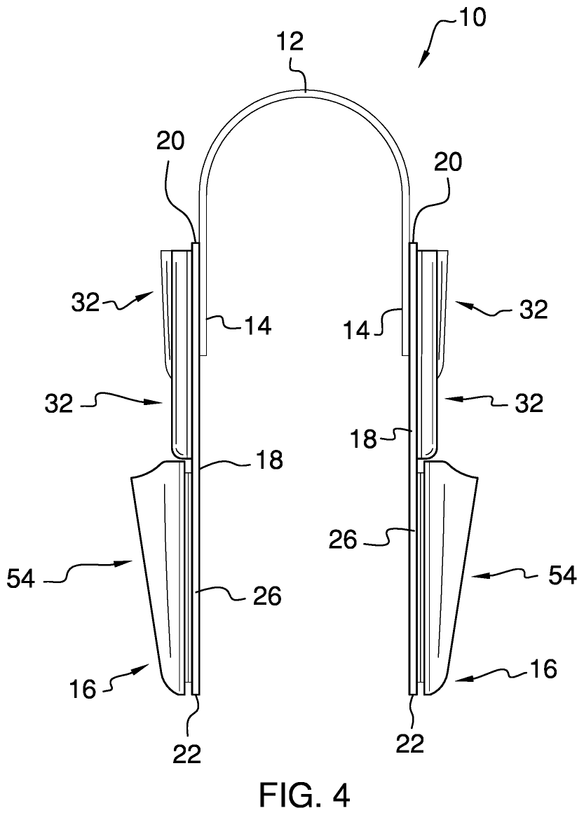

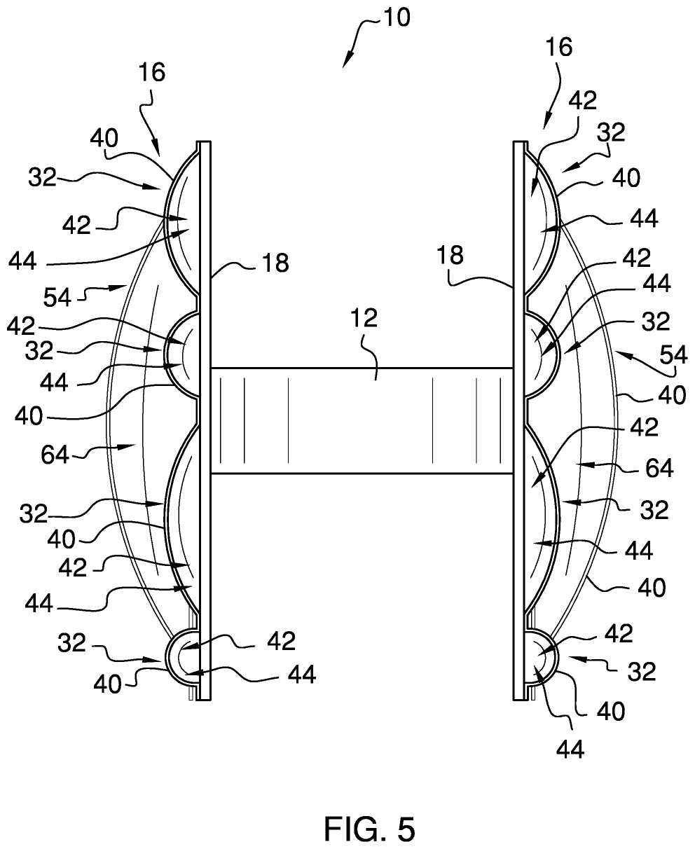

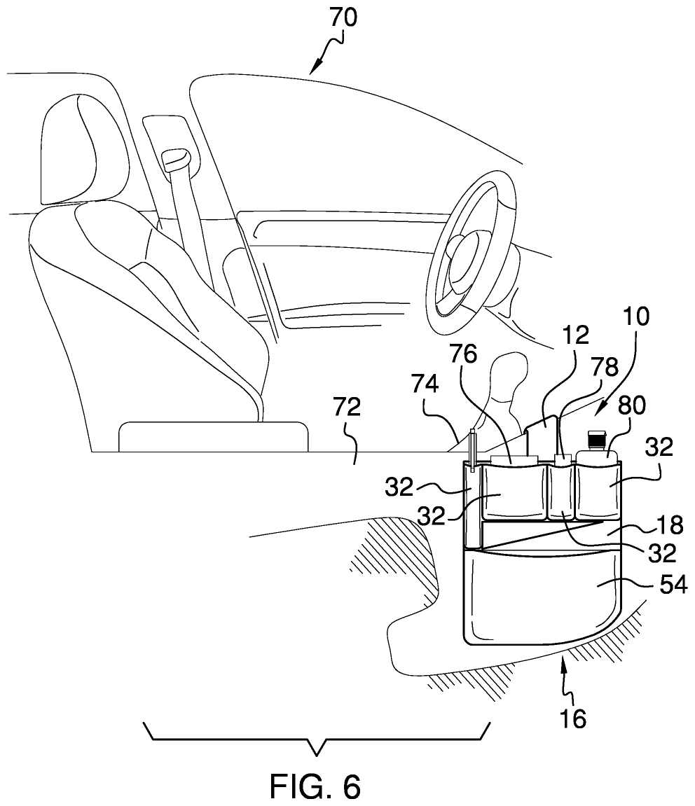

With reference now to the drawings, and in particular to FIGS. 1 through 6 thereof, a new organizer apparatus embodying the principles and concepts of an embodiment of the disclosure and generally designated by the reference numeral 10 will be described.

As best illustrated in FIGS. 1 through 6, the organizer apparatus 10 generally comprises a support strap 12 with a length such that the support strap 12 is configured to hang over a center console 72 of a vehicle 70. The support strap 12 comprises a bendable material so that the support strap 12 may bend to extend over the center console 72. The support strap 12 may be frictionally enhanced so that the support strap 12 remains stationary with respect to the center console 72. A suction cup may also be coupled to the support strap 12 and may be adhered to the center console 72 to fix the support strap 12 with respect to the center console 72.

Each one of a pair of compartment assemblies 16 is positioned on an associated end 14 of a pair of ends 14 of the support strap 12, and the compartment assemblies 16 lie opposite each other across the center console 72 when in use. Each compartment assembly 16 of the pair of compartment assemblies 16 comprises a panel 18, a plurality of pockets 32, a pouch 54, and a connector 68. The panel 18 has a top edge 20, a bottom edge 22, a front edge 24, and a rear edge 26. The panel 18 further has an outer surface 28 and an inner surface 30 each which each extend between the top edge 20 and the bottom edge 22 and between the front edge 24 and the rear edge 26. The panel 18 is positionable such that inner surface 30 abuts the center console 72 when the support strap 12 hangs over the center console 72. The panel 18 may comprise a friction reducing material such as a smooth polymer such that the compartment assemblies 16 may readily slide against the center console 72.

The plurality of pockets 32 is mounted on the outer surface 28 of the panel 18 adjacent to the top edge 20 of the panel 18. Each pocket 32 of the plurality of pockets 32 comprises a flexible wall 34. A lower edge 36 and a pair of lateral edges 38 of the flexible wall 34 of each pocket 32 of the plurality of pockets 32 is attached to the panel 18. The flexible wall 34 defines a chamber 42 between the flexible wall 34 and the panel 18, and an upper edge 40 of the flexible wall 34 is spaced from the panel 18 to define an opening 44 to the chamber 42.

The plurality of pockets 32 includes a pen pocket 46, a receipt pocket 48, a note pocket 50, and a sanitizer pocket 52. The flexible walls 34 of the plurality of pockets 32 are integrally formed with each other. The pen pocket 46 is positioned adjacent to the rear edge 26 of the panel 18 and is shaped and sized to hold a writing implement 74 such as a pen, a pencil, or the like. The pen pocket 46 has a width of between 0.9 inches and 1.1 inches and a height of between 5.0 inches and 5.5 inches.

The receipt pocket 48 is positioned adjacent to the pen pocket 46 opposite the rear edge 26 of the panel 18 and is shaped and sized to hold a receipt 76. The chamber 42 of the receipt pocket 48 has a width of between 3.25 inches and 3.75 inches and a height of between 2.8 inches and 3.2 inches. The note pocket 50 is positioned adjacent to the receipt pocket 48 opposite the pen pocket 46 and is shaped and sized to hold a notepad 78. The chamber 42 of the note pocket 50 has a width of between 1.4 inches and 1.6 inches and a height of between 2.8 inches and 3.2 inches. The sanitizer pocket 52 is positioned between the note pocket 50 and the front edge 24 of the panel 18 and is shaped and sized to hold a bottle 80 of hand sanitizer. The chamber 42 of the sanitizer pocket 52 has a width of between 2.25 inches and 2.75 inches and a height of between 2.8 inches and 3.2 inches.

The pouch 54 is coupled to the outer surface 28 of the panel 18. The pouch 54 comprises a rear wall 56 and a front wall 58 which are joined to each other on base edges 60 and a pair of side edges 62 of the rear wall 56 and the front wall 58. The pouch 54 defines a concavity 64 between the rear wall 56 and the front wall 58 which is open on a top end 66 of the concavity 64. The connector 68 is coupled to the pouch 54 and the panel 18 and releasably secures the pouch 54 to the panel 18. The connector 68 comprises a hook-and-loop fastener but may comprise a tie, a snap button, a zipper, or the like.

In use, the support strap 12 is placed on the center console 72 and the compartment assemblies 16 are positioned opposite each other across the center console 72. Items are storable as desired in each one of the plurality of pockets 32 and in the pouch 54 of each compartment assembly 16. The pouches 54 are also removable from the respective panels 18 to facilitate emptying, cleaning, and replacement of the pouch 54. The pouches 54 may, for example, be used to store waste and are removable to empty the waste remotely from the respective panel 18.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An organizer apparatus for use on a center console of a vehicle, the apparatus comprising:
a support strap, the support strap having a length such that the support strap is configured to hang over the center console; and
a pair of compartment assemblies, each compartment assembly of the pair of compartment assemblies being positioned on an associated end of a pair of ends of the support strap, each compartment assembly of the pair of compartment assemblies comprising:
a panel having a top edge, a bottom edge, a front edge, and a rear edge, the panel having an outer surface and an inner surface each extending between the top edge and the bottom edge and between the front edge and the rear edge, the panel being positionable such that inner surface abuts the center console when the support strap hangs over the center console; and
a plurality of pockets mounted on the outer surface of the panel.

2. The apparatus of claim 1, wherein the support strap comprises a bendable material.

3. The apparatus of claim 1, wherein each pocket of the plurality of pockets comprises a flexible wall, a lower edge and a pair of lateral edges of the flexible wall of each pocket of the plurality of pockets being attached to the panel, the flexible wall defining a chamber between the flexible wall and the panel, an upper edge of the flexible wall being spaced from the panel to define an opening to the chamber.

4. The apparatus of claim 1, wherein the plurality of pockets includes a pen pocket, the chamber of the pen pocket having a width of between 0.9 inches and 1.1 inches, the chamber of the pen pocket having a height of between 5.0 inches and 5.5 inches, wherein the pen pocket is configured for holding a writing implement.

5. The apparatus of claim 1, wherein the plurality of pockets includes a receipt pocket, the chamber of the receipt pocket having a width of between 3.25 inches and 3.75 inches, the chamber of the receipt pocket having a height of between 2.8 inches and 3.2 inches, wherein the receipt pocket is configured for holding a receipt.

6. The apparatus of claim 1, wherein the plurality of pockets includes a note pocket, the chamber of the note pocket having a width of between 1.4 inches and 1.6 inches, the chamber of the note pocket having a height of between 2.8 inches and 3.2 inches, wherein the note pocket is configured for holding a notepad.

7. The apparatus of claim 1, wherein the plurality of pockets includes a sanitizer pocket, the chamber of the sanitizer pocket having a width of between 2.25 inches and 2.75 inches, the chamber of the sanitizer pocket having a height of between 2.8 inches and 3.2 inches, wherein the sanitizer pocket is configured for holding a bottle of hand sanitizer.

8. The apparatus of claim 1, wherein each compartment assembly of the pair of compartment assemblies further comprises a pouch being coupled to the panel, the pouch comprising a rear wall and a front wall, the rear wall and the front wall being joined to each other on base edges and a pair of side edges of the rear wall and the front wall, the pouch defining a concavity between the rear wall and the front wall which is open on a top end of the concavity, the pouch being removable from the panel.

9. The apparatus of claim 8, wherein each compartment assembly of the pair of compartment assemblies further comprises a connector being coupled to the pouch and the panel, the connector being operable to releasably mount the pouch to the panel.

10. The apparatus of claim 9, wherein the connector comprises a hook-and-loop fastener.

11. An organizer apparatus for use on a center console of a vehicle, the apparatus comprising:
a support strap, the support strap having a length such that the support strap is configured to hang over the center console, the support strap comprising a bendable material; and
a pair of compartment assemblies, each compartment assembly of the pair of compartment assemblies being positioned on an associated end of a pair of ends of the support strap, each compartment assembly of the pair of compartment assemblies comprising:
a panel having a top edge, a bottom edge, a front edge, and a rear edge, the panel having an outer surface and an inner surface each extending between the top edge and the bottom edge and between the front edge and the rear edge, the panel being positionable such that inner surface abuts the center console when the support strap hangs over the center console;
a plurality of pockets mounted on the outer surface of the panel, the plurality of pockets being positioned adjacent to the top edge of the panel, each pocket of the plurality of pockets comprising a flexible wall, a lower edge and a pair of lateral edges of the flexible wall of each pocket of the plurality of pockets being attached to the panel, the flexible wall defining a chamber between the flexible wall and the panel, an upper edge of the flexible wall being spaced from the panel to define an opening to the chamber, the plurality of pockets including:
a pen pocket being positioned adjacent to the rear edge of the panel, the chamber of the pen pocket having a width of between 0.9 inches and 1.1 inches, the chamber of the pen pocket having a height of between 5.0 inches and 5.5 inches, wherein the pen pocket is configured for holding a writing implement;
a receipt pocket being positioned adjacent to the pen pocket opposite the rear edge of the panel, the chamber of the receipt pocket having a width of between 3.25 inches and 3.75 inches, the chamber of the receipt pocket having a height of between 2.8 inches and 3.2 inches, wherein the receipt pocket is configured for holding a receipt;
a note pocket being positioned adjacent to the receipt pocket opposite the pen pocket, the chamber of the note pocket having a width of between 1.4 inches and 1.6 inches, the chamber of the note pocket having a height of between 2.8 inches and 3.2 inches, wherein the note pocket is configured for holding a notepad;
a sanitizer pocket being positioned between the note pocket and the front edge of the panel, the chamber of the sanitizer pocket having a width of between 2.25 inches and 2.75 inches, the chamber of the sanitizer pocket having a height of between 2.8 inches and 3.2 inches, wherein the sanitizer pocket is configured for holding a bottle of hand sanitizer; and
wherein the flexible walls of the plurality of pockets are integrally formed with each other;
a pouch being coupled to the panel, the pouch comprising a rear wall and a front wall, the rear wall and the front wall being joined to each other on base edges and a pair of side edges of the rear wall and the front wall, the pouch defining a concavity between the rear wall and the front wall which is open on a top end of the concavity, the pouch being removable from the panel; and
a connector being coupled to the pouch and the panel, the connector being operable to releasably mount the pouch to the panel, the connector comprising a hook-and-loop fastener.
